(19) United States
(12) Patent Application Publication
(10) Pub. No.: US 2023/0407784 A1
(43) Pub. Date: Dec. 21, 2023

(54) FUEL SUPPLY METHOD, FUEL SUPPLY SYSTEM, FUEL COMBUSTION SYSTEM PROVIDED WITH FUEL SUPPLY SYSTEM, AND GAS TURBINE PLANT

(71) Applicant: MITSUBISHI HEAVY INDUSTRIES, LTD., Tokyo (JP)

(72) Inventors: Hiroyuki TAKEISHI, Tokyo (JP); Keisuke MIURA, Tokyo (JP); Keita YUNOKI, Tokyo (JP); Yoshitaka HIRATA, Tokyo (JP); Akinori HAYASHI, Tokyo (JP); Tatsuya HAGITA, Tokyo (JP); Satoshi TANIMURA, Tokyo (JP)

(21) Appl. No.: 18/228,841

(22) Filed: Aug. 1, 2023

Related U.S. Application Data
(63) Continuation of application No. PCT/JP2022/005121, filed on Feb. 9, 2022.

(30) Foreign Application Priority Data
Feb. 15, 2021 (JP) 2021-021753

(51) Int. Cl. F02C 3/22; F02C 7/224

(52) U.S. Cl. CPC F02C 3/22; F05D 2240/36; F05D 2220/75; F02C 7/224

(57) ABSTRACT

Provided is a fuel supply system including a main ammonia line through which liquid ammonia flows; a vaporizer connected to an end of the main ammonia line and configured to heat and vaporize the liquid ammonia via heat exchange between a heating medium and the liquid ammonia; a gaseous ammonia line connected to the vaporizer, the gaseous ammonia line configured to guide a gaseous ammonia, which is ammonia vaporized by the vaporizer, as fuel to a combustor of a gas turbine; a liquid ammonia line configured to guide liquid ammonia which has not undergone heat exchange with the heating medium at the vaporizer as fuel to the combustor; and a switching device configured to switch an ammonia supply state between a first state in which the gaseous ammonia is guided from the gaseous ammonia line to the combustor and a second state in which the liquid ammonia is guided from the liquid ammonia line to the combustor.

This application claims priority based on JP 2021-021753 filed in Japan on Feb. 15, 2021, of which the contents are incorporated herein by reference. This application is a continuation application based on a PCT Patent Application No. PCT/JP2022/005121 whose priority is claimed on JP 2021-021753. The contents of the PCT Application is incorporated herein by reference.

### TECHNICAL FIELD

The present disclosure relates to a fuel supply method for supplying ammonia as fuel for a gas turbine, a fuel supply system, a fuel combustion system provided with the fuel supply system, and a gas turbine plant.

### BACKGROUND ART

A gas turbine includes a compressor that compresses air, a combustor that generates a combustion gas by burning a fuel in the air compressed by the compressor, and a turbine driven using the combustion gas. In Patent Document 1, an example of using ammonia as fuel supplied to a combustor is described.

### CITATION LIST

### Patent Document

Patent Document 1: WO 2018/181002

### SUMMARY OF INVENTION

### Technical Problem

In a case in which ammonia is used as fuel for a gas turbine, some of the nitrogen composing the ammonia becomes NOx. Thus, in a case in which ammonia is used as fuel for a gas turbine, it is desirable to reduce the amount of NOx generated. Furthermore, even in a case in which ammonia is used as a fuel for a gas turbine, it is desirable to combust ammonia as stably as possible, as in the case in which natural gas or the like is used as fuel for a gas turbine.

Thus, the present disclosure is directed at providing technology relating to using ammonia as fuel for a gas turbine, with which ammonia can be stably supplied in the time from activation of the gas turbine until operation at the rated load, ammonia can be stably combusted, and NOx generation can be suppressed.

### Solution to Problem

In order to achieve the object described above, a fuel supply system according to an aspect includes a main ammonia line connected to an ammonia tank configured to store liquid ammonia; a main ammonia pump provided on the main ammonia line, the main ammonia pump configured to pressurize the liquid ammonia from the ammonia tank; a vaporizer connected to an end of the main ammonia line, the vaporizer configured to heat and vaporize the liquid ammonia via heat exchange between a heating medium and the liquid ammonia pressurized by the main ammonia pump; a gaseous ammonia line connected to the vaporizer, the gaseous ammonia line configured to guide gaseous ammonia, which is ammonia vaporized by the vaporizer, as fuel to a combustor of a gas turbine; a liquid ammonia line configured to guide liquid ammonia, which is liquid ammonia pressurized by the main ammonia pump and that has not undergone heat exchange with the heating medium at the vaporizer, as fuel to the combustor; and a switching device configured to switch an ammonia supply state between a plurality of states including a first state in which the gaseous ammonia is guided from the gaseous ammonia line to the combustor and a second state in which the liquid ammonia is guided from the liquid ammonia line to the combustor.

In the present aspect, the gaseous ammonia can be guided to the combustor and the liquid ammonia can be guided to the combustor. When considering the operation of a gas turbine, gaseous ammonia cannot be supplied to the combustor at a predetermined pressure unless energy is supplied from the outside at the time of startup. Thus, it is preferable to supply liquid ammonia to the combustor at the time of startup. On the other hand, in a case in which the gaseous ammonia is sprayed from the fuel nozzle of the combustor as fuel, the generation of NOx can be suppressed. When the fuel flow rate is low, the likelihood of the fuel misfiring is high. However, because the flow rate of ammonia is low, the amount of NOx generated is low. Conversely, when the fuel flow rate is high, the likelihood of the fuel misfiring is low. However, because the flow rate of ammonia is high, the amount of NOx generated is high. Thus, when the fuel flow rate is low, the liquid ammonia is guided to the combustor to reduce the likelihood of the fuel misfiring and to stably combust the fuel. Also, when the fuel flow rate is high, in order to suppress the generation of NOx, the gaseous ammonia is guided to the combustor. As a result, by supplying liquid ammonia to the combustor at startup, ammonia serving as fuel can be supplied to the combustor even without external thermal energy supply. Furthermore, in the present aspect, NOx generation can be reduced while also achieving stable combustion of ammonia during the time from startup to rated operation without using a fuel other than ammonia.

In order to achieve the object described above, a fuel combustion system according to an aspect includes the fuel supply system according to the aspect described above and the combustor that combusts the fuel from the fuel supply system in a compressed air and generates combustion gas.

In order to achieve the object described above, a gas turbine plant according to an aspect includes the fuel supply system according to the aspect described above and the gas turbine. The gas turbine includes a compressor that compresses air to generate compressed air, the combustor that combusts the fuel from the fuel supply system in the compressed air to generate combustion gas, and a turbine configured to be driven by the combustion gas.

In order to achieve the object described above, a fuel supply method according to an aspect includes pressurizing liquid ammonia from an ammonia tank storing the liquid ammonia; vaporizing the liquid ammonia by heating the liquid ammonia via heat exchange between a heating medium and the liquid ammonia pressurized in the pressurizing; and switching an ammonia supply state between a plurality of states including a first state in which a gaseous ammonia, which is ammonia vaporized in the vaporizing, is guided to a combustor of a gas turbine as fuel and a second state in which liquid ammonia, which is liquid ammonia pressurized in the pressurizing which has not undergone heat exchange with the heating medium in the vaporizing, is guided to the combustor as fuel.

### Advantageous Effects of Invention

According to an aspect of the present disclosure, ammonia can be stably combusted and NOx generation can be suppressed.

### BRIEF DESCRIPTION OF DRAWINGS

FIG. 1 is a system diagram illustrating a gas turbine plant of a first embodiment according to the present disclosure.

FIG. 2 is a cross-sectional view illustrating a fuel nozzle of an embodiment according to the present disclosure.

FIG. 3 is a flowchart illustrating a process for performing a fuel supply method of an embodiment according to the present disclosure.

FIG. 4 is a graph illustrating changes in the fuel flow rate percent over time in an embodiment according to the present disclosure.

FIG. 5 is a graph illustrating the relationship between fuel/air ratio and NOx concentration in an embodiment according to the present disclosure.

FIG. 6 is a system diagram illustrating a gas turbine plant of a second embodiment according to the present disclosure.

FIG. 7 is a system diagram illustrating a gas turbine plant of a third embodiment according to the present disclosure.

FIG. 8 is a graph illustrating changes in the fuel flow rate percent over time in a first modified example according to the present disclosure.

FIG. 9 is a system diagram illustrating a gas turbine plant of a second modified example according to the present disclosure.

FIG. 10 is a system diagram illustrating a gas turbine plant of a third modified example according to the present disclosure.

### DESCRIPTION OF EMBODIMENTS

Embodiments and modified examples of the present disclosure are described below with reference to the drawings.

### First Embodiment

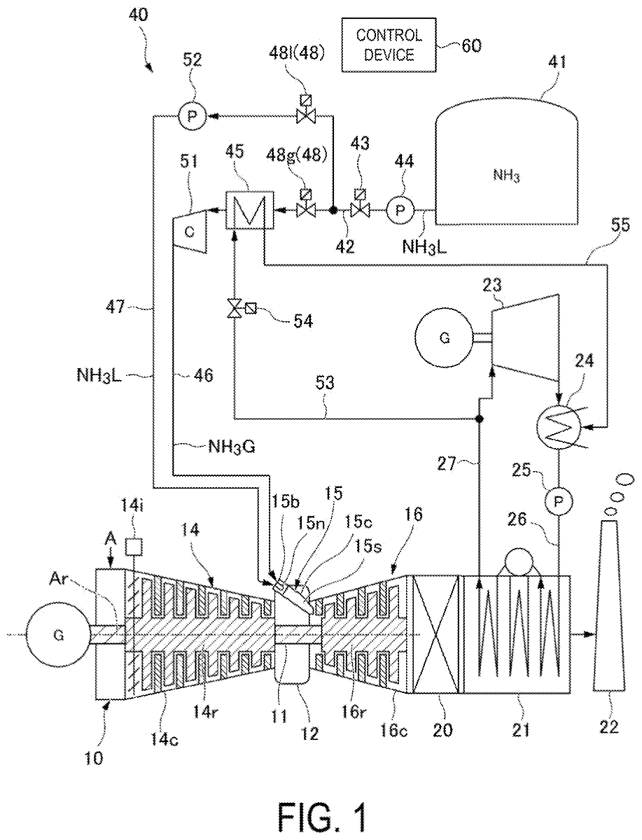

The first embodiment of a gas turbine plant according to the present disclosure will be described below with reference to FIGS. 1 to 5.

As illustrated in FIG. 1, the gas turbine plant of the present embodiment is provided with a gas turbine 10, a denitrification device 20 that decomposes the NOx component contained in the exhaust gas from the gas turbine 10, a waste heat recovery boiler 21 that generates steam using the heat from the exhaust gas output from the denitrification device 20, a stack 22 that discharges the exhaust gas from the waste heat recovery boiler 21 to the outside, a steam turbine 23 driven by steam from the waste heat recovery boiler 21, a condenser 24 that causes steam from the steam turbine 23 to revert to water, a pump 25 that sends water in the condenser 24 to the waste heat recovery boiler 21, a fuel supply system 40 that supplies fuel to the gas turbine 10, and a control device 60. Note that the denitrification device 20 may be disposed inside the waste heat recovery boiler 21.

The gas turbine 10 is provided with a compressor 14 that compresses air A, a combustor 15 that combusts the fuel in the air compressed by the compressor 14 to generate combustion gas, and a turbine 16 that is driven by the high-temperature high-pressure combustion gas.

The compressor 14 includes a compressor rotor 14r that rotates about a rotor axis Ar, a compressor casing 14c that covers the compressor rotor 14r, and an inlet guide vane (IGV) 14i provided at the inlet of the compressor casing 14c. The IGV 14i adjusts the flow rate of the air taken into the compressor casing 14c according to an instruction from the control device 60.

The turbine 16 includes a turbine rotor 16r that is caused to rotate about the rotor axis Ar by the combustion gas from the combustor 15 and a turbine casing 16c that covers the turbine rotor 16r. The turbine rotor 16r and the compressor rotor 14r are connected together in a manner allowing both to rotate about the same rotor axis Ar, forming a gas turbine rotor 11. For example, a rotor of a generator is connected to the gas turbine rotor 11.

The gas turbine 10 is further provided with an intermediate casing 12. The intermediate casing 12 is disposed between the compressor casing 14c and the turbine casing 16c in the direction the rotor axis Ar extends and is connected to the compressor casing 14c and the turbine casing 16c. The compressed air discharged from the compressor 14 flows into the intermediate casing 12.

The combustor 15 is fixed to the intermediate casing 12. The combustor 15 is provided with a combustion liner (or transition piece) 15c with a combustion chamber 15s formed inside and a combustor main body 15b that sprays fuel and compressed air into the combustion chamber 15s. The combustion liner 15c forming the combustion chamber 15s corresponds to a combustion chamber forming device. In the combustion chamber 15s, fuel is combusted in compressed air. The combustion gas produced by fuel combustion flows through the combustion chamber 15s and is sent to the turbine 16. The combustor main body 15b includes a fuel nozzle 15n that sprays fuel into the combustion chamber 15s.

Ammonia is supplied to the denitrification device 20. The denitrification device 20 uses this ammonia to decompose NOx contained in the exhaust gas from the gas turbine 10 into nitrogen and water vapor.

The waste heat recovery boiler 21 and the condenser 24 are connected by a feedwater line 26. The feedwater line 26 is provided with the pump 25 that sends water in the condenser 24 to the waste heat recovery boiler 21. The waste heat recovery boiler 21 and the steam turbine 23 are connected by a main steam line 27. The waste heat recovery boiler 21 uses the heat of the exhaust gas from the gas turbine 10 to convert the water from the feedwater line 26 into steam. This steam is sent to the steam turbine 23 via the main steam line 27. A rotor of the steam turbine 23 is connected to the rotor of a power generator, for example. Next, the steam exhausted from the steam turbine 23 is reverted into water at the condenser 24.

The fuel supply system 40 includes an ammonia tank 41, a main ammonia line 42, a flow control valve 43, a main ammonia pump 44, a vaporizer 45, a gaseous ammonia line 46, a liquid ammonia line 47, a switching device 48, a gaseous ammonia compressor 51, a liquid ammonia pump 52, a heating medium line 53, a heating medium valve 54, and a heating medium recovery line 55.

In the ammonia tank 41, liquid ammonia NH₃(l) is stored. The main ammonia line 42 is connected to the ammonia tank 41. The main ammonia line 42 is provided with the main ammonia pump 44 that pressurizes the liquid ammonia NH₃(l) from the ammonia tank 41 and the flow control valve 43 that adjusts the flow rate of the ammonia flowing through the main ammonia line 42. The end of the main ammonia line 42 is connected to the ammonia inlet of the vaporizer 45.

The vaporizer 45 is a heat exchanger where heat exchange occurs between steam, i.e., the heating medium, and the liquid ammonia NH₃(l) and where the liquid ammonia NH₃(l) is heated and vaporized. One end of the heating medium line 53 is connected to the medium inlet of the vaporizer 45. The other end of the heating medium line 53 is connected to the main steam line 27. The heating medium line 53 is provided with the heating medium valve 54 that adjusts the flow rate of the steam flowing through the heating medium line 53. One end of the heating medium recovery line 55 is connected to the medium outlet of the vaporizer 45. The other end of the heating medium recovery line 55 is connected to the condenser 24. Note that the other end of the heating medium recovery line 55 need not be connected to the condenser 24 and may be connected to the portion in the waste heat recovery boiler 21 where water flows.

One end of the gaseous ammonia line 46 is connected to the ammonia outlet of the vaporizer 45. The other end of the gaseous ammonia line 46 is connected to the fuel nozzle 15n of the combustor 15. The gaseous ammonia line 46 is provided with the gaseous ammonia compressor 51 that pressurizes the gaseous ammonia NH₃(g) flowing through the gaseous ammonia line 46.

One end of the liquid ammonia line 47 is connected to the main ammonia line 42 at a position between the main ammonia pump 44 and the vaporizer 45. The other end of the liquid ammonia line 47 is connected to the fuel nozzle 15n of the combustor 15. The liquid ammonia line 47 is provided with the liquid ammonia pump 52 that pressurizes the liquid ammonia NH₃(l) flowing through the liquid ammonia line 47.

The flow control valve 43 is provided on the main ammonia line 42 at a position between the connection position of the liquid ammonia line 47 and the main ammonia pump 44. The flow control valve 43 adjusts the flow rate of the fuel supplied to the combustor 15 by adjusting the flow rate of the liquid ammonia NH₃(l) flowing through the main ammonia line 42.

The switching device 48 switches the ammonia supply state between a first state in which the gaseous ammonia NH₃(g) is guided from the gaseous ammonia line 46 to the fuel nozzle 15n of the combustor 15, a second state in which the liquid ammonia NH₃(l) is guided from the liquid ammonia line 47 to the fuel nozzle 15n of the combustor 15, and a third state in which the gaseous ammonia NH₃(g) from the gaseous ammonia line 46 and the liquid ammonia NH₃(l) from the liquid ammonia line 47 are guided to the fuel nozzle 15n of the combustor 15. The switching device 48 includes a gaseous ammonia flow control valve 48g and a liquid ammonia flow control valve 48i. The gaseous ammonia flow control valve 48g is provided on the main ammonia line 42 at a position between the connection position of the liquid ammonia line 47 and the vaporizer 45. The gaseous ammonia flow control valve 48g adjusts the flow rate of the gaseous ammonia NH₃(g) supplied to the combustor 15 via the gaseous ammonia line 46 by adjusting the flow rate of the liquid ammonia NH₃(l) introduced from the main ammonia line 42 to the vaporizer 45. The liquid ammonia flow control valve 48i is provided on the liquid ammonia line 47. The liquid ammonia flow control valve 48i adjusts the flow rate of the liquid ammonia NH₃(l) flowing through the liquid ammonia line 47.

The first state can be implemented by putting the liquid ammonia flow control valve 48i into a closed state and the gaseous ammonia flow control valve 48g into an open state. The second state can be implemented by putting the liquid ammonia flow control valve 48i into an open state and the gaseous ammonia flow control valve 48g into a closed state. The third state can be implemented by putting both the liquid ammonia flow control valve 48i and the gaseous ammonia flow control valve 48g into a half-open state.

The switching device 48 can use one three-way valve instead of the gaseous ammonia flow control valve 48g and the liquid ammonia flow control valve 48i. In this case, the three-way valve is provided at a position where the main ammonia line 42 and the liquid ammonia line 47 connect. The three-way valve adjusts the ratio between the flow rate of the liquid ammonia NH₃(l) introduced to the vaporizer 45 and the flow rate of the liquid ammonia NH₃(l) that flows through the liquid ammonia line 47.

In the present embodiment, the fuel combustion system is provided with the fuel supply system 40 and the combustor 15.

The control device 60 receives an external output request for the gas turbine 10 and controls the operation of the flow control valve 43 and the switching device 48 in accordance with the output request. Note that the control device 60 is a computer. The control device 60 includes, as hardware, a central processing unit (CPU) that performs various calculations, a primary storage device such as a memory providing a working area for the CPU, an auxiliary storage device such as a hard disk drive device, an input device such as a keyboard and mouse, and a display device. The control device 60 functions via the CPU executing a control program stored in the auxiliary storage device, for example.

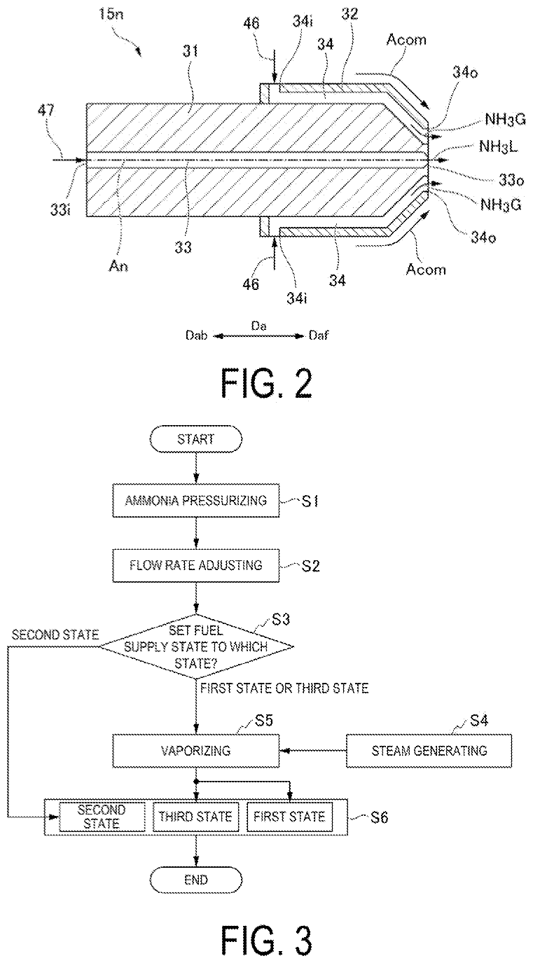

As illustrated in FIG. 2, the fuel nozzle 15n of the combustor 15 includes an inner cylinder 31 with a cylindrical shape surrounding a nozzle axis An and an outer cylinder 32 with a cylindrical shape surrounding the nozzle axis An that is disposed on the outer circumferential side on the inner cylinder 31. Herein, the direction in which the nozzle axis An extends is defined as an axial direction Da, with the two sides of the axial direction Da being defined as a back side Dab and a front side Daf. The position of the end on the inner cylinder 31 on the front side Daf and the position of the end of the outer cylinder 32 on the front side Daf are essentially the same as the position in the axial direction Da. The inner circumferential side of the inner cylinder 31 forms a liquid fuel flow path 33. The liquid fuel flow path 33 includes a liquid fuel inlet 33i and a liquid fuel spray port 33o. The end of the liquid fuel flow path 33 on the back side Dab corresponds to the liquid fuel inlet 33i, and the end of the liquid fuel flow path 33 on the front side Daf corresponds to the liquid fuel spray port 33o. The liquid ammonia line 47 is connected to the liquid fuel inlet 33i. A fuel gas flow path 34 is formed between the outer circumferential side of the inner cylinder 31 and the inner circumferential side of the outer cylinder 32. The fuel gas flow path 34 includes a fuel gas inlet 34i and a fuel gas spray port 34o. An opening is formed in a portion on the back side Dab of the outer cylinder 32 in the outer circumferential surface of the outer cylinder 32. The opening corresponds to the fuel gas inlet 34i of the fuel gas flow path 34, and the end of the fuel gas flow path 34 on the front side Daf corresponds to the fuel gas spray port 34o. The gaseous ammonia line 46 is connected to the fuel gas inlet 34i. A compressed air Acom from the compressor 14 flowing toward the front side Daf from the end of the outer cylinder 32 on the front side Daf on the outer circumferential side of the outer cylinder 32 flows as combustion air.

Next, the process of the fuel supply method for the gas turbine plant described above is described according to the flowchart illustrated in FIG. 3.

In the fuel supply method, an ammonia pressurizing step S1, a flow rate adjusting step S2, a switch controlling step S3, a steam generating step S4, a vaporizing step S5, and a switching step S6 are performed.

In the ammonia pressurizing step S1, the liquid ammonia NH₃(l) pumped by the main ammonia pump 44 from the ammonia tank 41 to the main ammonia line 42 is pressurized. In the flow rate adjusting step S2, the flow rate of the liquid ammonia NH₃(l) flowing through the main ammonia line 42 is adjusted by the flow control valve 43. The flow rate of the fuel supplied to the combustor 15 is adjusted by adjusting the flow rate of the liquid ammonia NH₃(l). The control device 60 receives an output request for the gas turbine 10. The control device 60 determines the flow rate of the fuel supplied to the combustor 15 in accordance with the output request. The flow rate of the fuel has a positive correlation with the output request. That is, when the output request is high, the flow rate of the fuel is determined such that the flow rate of fuel is high. The control device 60 instructs the flow control valve 43 to make the flow rate of the fuel supplied to the combustor 15 the determined flow rate.

In the switch controlling step S3, the control device 60 determines the fuel supply state to be one of the first state, the second state, or the third state, and instructs the switching device 48 to implement the determined state.

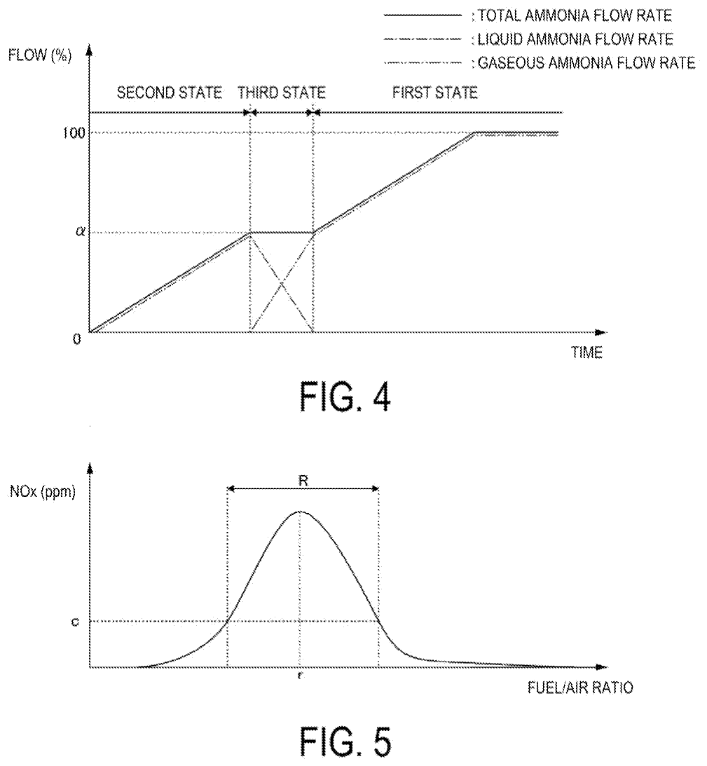

A method for determining the fuel supply state using the control device 60 will now be described with reference to FIG. 4. The amount of fuel supplied to the gas turbine 10 gradually increases over time during the time period from startup to rated operation. Also, as described above, the flow rate of the fuel supplied to the combustor 15 in a case in which the output request is less than the rated output is less than the flow rate of the fuel supplied to the combustor 15 in a case in which the output request is the rated output. Herein, the fuel flow rate percentage when the output request is the rated output is 100%, and the fuel flow rate percentage before startup is 0%. Furthermore, the fuel flow rate percentage when the output request is a predetermined output less than the rated output is α %.

The control device 60 selects the second state from among the first state, the second state, and the third state in a case in which the fuel flow rate percentage determined according to the output request is greater than 0% and less than α %, i.e., a low fuel flow rate. As described above, the second state is a state in which only the liquid ammonia NH₃(l) is guided to the fuel nozzle 15n as fuel. As described above, the third state is selected from among the first state, the second state, and the third state in a case in which the fuel flow rate percentage determined according to the output request is α %. The third state is a state in which the liquid ammonia NH₃(l) and the gaseous ammonia NH₃(g) are guided to the fuel nozzle 15n as fuel. The first state is selected from among the first state, the second state, and the third state in a case in which the fuel flow rate percentage determined according to the output request is greater than α %. As described above, the first state is a state in which only the gaseous ammonia NH₃(g) is guided to the fuel nozzle 15n as fuel. The control device 60 instructs the switching device 48 to implement the selected state.

In the steam generating step S4, heat exchange between the exhaust gas from the gas turbine 10 and water occurs at the waste heat recovery boiler 21, converting the water into steam.

The vaporizing step S5 is performed in a case in which, in the switch controlling step S3, the fuel supply state is set to the first state or the third state and is not performed in a case in which the fuel supply state is set to the second state. In the vaporizing step S5, at the vaporizer 45, the liquid ammonia NH₃(l) is heated by a heating medium and vaporized. Some of the steam generated in the steam generating step S4 is used in the steam functioning as a heating medium.

In the switching step S6, the switching device 48 operates to implement the state corresponding to the instruction from the control device 60 from among the first state, the second state, and the third state.

For example, in a case in which the instruction from the control device 60 is for the first state, regarding the gaseous ammonia flow control valve 48g and the liquid ammonia flow control valve 48i of the switching device 48, the gaseous ammonia flow control valve 48g is opened and the liquid ammonia flow control valve 48i is closed. As a result, the liquid ammonia NH₃(l) is guided to the vaporizer 45 via the main ammonia line 42 and the gaseous ammonia flow control valve 48g, where it is converted to the gaseous ammonia NH₃(g). The gaseous ammonia NH₃(g) is guided to the combustor 15 via the gaseous ammonia line 46 and the gaseous ammonia compressor 51. On the other hand, the liquid ammonia NH₃(l) pressurized at the main ammonia pump 44 is not sent through the liquid ammonia line 47. Thus, in the first state performed when the fuel flow rate is high, only the gaseous ammonia NH₃(g) is supplied to the fuel nozzle 15n of the combustor 15 as fuel. The gaseous ammonia NH₃(g) is sent to the fuel gas flow path 34 of the fuel nozzle 15n and sprayed from the fuel gas spray port 34o into the combustion liner 15c.

Also, in a case in which the instruction from the control device 60 is for the second state, regarding the gaseous ammonia flow control valve 48g and the liquid ammonia flow control valve 48i of the switching device 48, the gaseous ammonia flow control valve 48g is closed and the liquid ammonia flow control valve 48i is opened. As a result, the liquid ammonia NH₃(l) is guided to the combustor 15 via the liquid ammonia line 47, the liquid ammonia flow control valve 48i, and the liquid ammonia pump 52. On the other hand, the liquid ammonia NH₃(l) pressurized at the main ammonia pump 44 is not guided to the vaporizer 45. Thus, in the second state performed when the fuel flow rate is low, only the liquid ammonia NH₃(l) is supplied to the fuel nozzle 15n of the combustor 15 as fuel. The liquid ammonia NH₃(l) is sent to the liquid fuel flow path 33 of the fuel nozzle 15n and sprayed from the liquid fuel spray port 33o into the combustion liner 15c.

Also, in a case in which the instruction from the control device 60 is for the third state, the gaseous ammonia flow control valve 48g and the liquid ammonia flow control valve 48i of the switching device 48 are both half opened. As a result, the liquid ammonia NH₃(l) is guided to the vaporizer 45 via the main ammonia line 42 and the gaseous ammonia flow control valve 48g, where it is converted to the gaseous ammonia NH₃(g). The gaseous ammonia NH₃(g) is guided to the combustor 15 via the gaseous ammonia line 46 and the gaseous ammonia compressor 51. Also, the liquid ammonia NH₃(l) is also sent to the liquid ammonia line 47 and then guided to the combustor 15 via the liquid ammonia line 47, the liquid ammonia flow control valve 48i, and the liquid ammonia pump 52. Thus, in the third state performed when the fuel flow rate is the α % fuel flow rate between a low fuel flow rate and a high fuel flow rate, the liquid ammonia NH₃(l) and the gaseous ammonia NH₃(g) are both supplied to the fuel nozzle 15n of the combustor 15 as fuel. The gaseous ammonia NH₃(g) is sent to the fuel gas flow path 34 of the fuel nozzle 15n and sprayed from the fuel gas spray port 34o into the combustion liner 15c. Also, the liquid ammonia NH₃(l) is sent to the liquid fuel flow path 33 of the fuel nozzle 15n and sprayed from the liquid fuel spray port 33o into the combustion liner 15c.

However, as illustrated in FIG. 4, when the fuel flow rate transitions from a low fuel flow rate, through the α % fuel flow rate, and to a high fuel flow rate, the α % fuel flow rate is maintained for a predetermined amount of time or more. In the third state performed when the fuel flow rate is the α % fuel flow rate, during a predetermined amount of time, the liquid ammonia flow control valve 48i gradually closes over time and the flow rate of the liquid ammonia NH₃(l) guided to the combustor 15 gradually decreases over time. In the third state, during a predetermined amount of time, the gaseous ammonia flow control valve 48g gradually opens over time and the flow rate of the gaseous ammonia NH₃(g) guided to the combustor 15 gradually increases over time. Also, when the fuel flow rate transitions from a high fuel flow rate, through the α % fuel flow rate, and to a low fuel flow rate, the α % fuel flow rate is maintained for a predetermined amount of time or more. In the third state performed when the fuel flow rate is the α % fuel flow rate, the gaseous ammonia flow control valve 48g gradually closes over time and the flow rate of the gaseous ammonia NH₃(g) guided to the combustor 15 gradually decreases over time. In the third state, the liquid ammonia flow control valve 48i gradually opens over time and the flow rate of the liquid ammonia NH₃(l) guided to the combustor 15 gradually increases over time.

In a case in which ammonia is used as fuel for the gas turbine 10, some of the nitrogen composing the ammonia becomes NOx. The amount of NOx generated depends on the flow rate of ammonia used as the fuel and the fuel/air ratio. When the flow rate of ammonia used as the fuel is high, a large amount of NOx is generated, and when the flow rate of ammonia used as the fuel is low, a low amount of NOx is generated. In addition, as illustrated in FIG. 5, the NOx concentration in the combustion gas reaches a maximum when the fuel/air ratio is a value r. The NOx concentration gradually decreases as the fuel/air ratio decreases below the value r. Also, the NOx concentration gradually decreases as the fuel/air ratio increases above the value r.

Thus, in the present embodiment, the fuel/air ratio is controlled so that the value of the fuel/air ratio does not become a value in the predetermined fuel/air ratio range R where the NOx concentration is higher than a predetermined value c. The control of the fuel/air ratio is performed by the control device 60. As described above, the control device 60 determines the flow rate of the fuel according to an output request. Then, the control device 60 determines the degree of opening of the IGV 14i on the basis of the determined fuel flow rate and sends this degree of opening as an instruction to the IGV 14i. At this time, the control device 60 determines the degree of opening of the IGV 14i in a manner such that the value of the fuel/air ratio, which is a ratio between the determined fuel flow rate and the flow rate of air taken in by the compressor 14, does not become a value in the predetermined fuel/air ratio range R described above.

As described above, in the present embodiment, the gaseous ammonia NH₃(g) can be guided to the combustor 15 and the liquid ammonia NH₃(l) can be guided to the combustor 15. In a case in which the liquid ammonia NH₃(l) is sprayed from the fuel nozzle 15n of the combustor 15 as fuel, misfire and the like can be reduced and the fuel can be stably combusted. On the other hand, in a case in which the gaseous ammonia NH₃(g) is sprayed from the fuel nozzle 15n of the combustor 15 as fuel, the generation of NOx can be suppressed. When the fuel flow rate is low, the likelihood of the fuel misfiring is high. However, because the flow rate of ammonia is low, the amount of NOx generated is low. Conversely, when the fuel flow rate is high, the likelihood of the fuel misfiring is low. However, because the flow rate of ammonia is high, the amount of NOx generated is high. Thus, in the present embodiment, as described above, when the fuel flow rate is low, the liquid ammonia NH₃(l) is guided to the combustor 15 to reduce the likelihood of the fuel misfiring and to stably combust the fuel. Also, in the present embodiment, when the fuel flow rate is high, in order to suppress the generation of NOx, the gaseous ammonia NH₃(g) is guided to the combustor 15. Thus, in the present embodiment, by supplying liquid ammonia to the combustor at startup, ammonia serving as fuel can be supplied to the combustor even without external thermal energy supply. Furthermore, in the present embodiment, NOx generation can be reduced while also achieving stable combustion of ammonia during the time from startup to rated operation without using a fuel other than ammonia.

Also, as described above, in the present embodiment, the fuel/air ratio is controlled so that the value of the fuel/air ratio does not become a value in the predetermined fuel/air ratio range R where the NOx concentration is higher than a predetermined value c. Thus, according to this embodiment, NOx generation can be reduced from this perspective as well.

In addition, in the present embodiment, the combustion gas exhausted from the gas turbine 10 is discharged to the outside from the stack 22 after passing through the denitrification device 20. Thus, in the present embodiment, the amount of NOx emission can be reduced.

In a case in which the state transitions from a state in which only the gaseous ammonia NH₃(g) is being guided to the combustor 15 to a state in which only the liquid ammonia NH₃(l) is being guided to the combustor 15 or conversely in a case in which the state transitions from a state in which only the liquid ammonia NH₃(l) is being guided to the combustor 15 to a state in which only the gaseous ammonia NH₃(g) is being guided to the combustor 15, if the phase of the fuel sprayed from the fuel nozzle 15n of the combustor 15 suddenly changes, the stability of the fuel combustion is impaired. The fuel nozzle 15n of the present embodiment includes the liquid fuel flow path 33 and the fuel gas flow path 34 and is configured to spray the liquid ammonia NH₃(l) and the gaseous ammonia NH₃(g) at the same time. Furthermore, in the present embodiment, in the process of transitioning from the first state to the second state or in the process of transitioning from the second state to the first state, both the liquid ammonia NH₃(l) and the gaseous ammonia NH₃(g) are guided to the fuel nozzle 15n of the combustor 15 as fuel. Thus, in the present embodiment, the stability of the combustion of the fuel can be ensured in the transition process described above.

### Second Embodiment

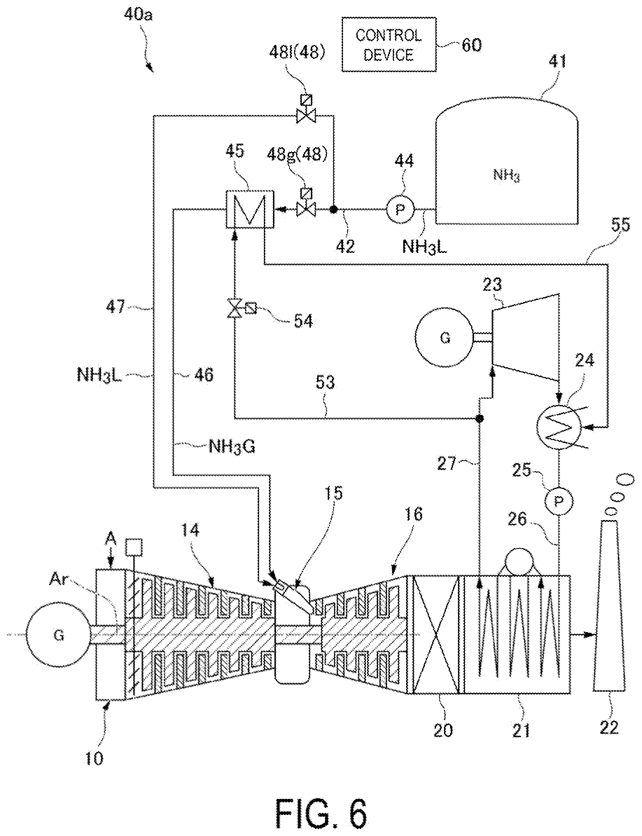

A second embodiment of a gas turbine plant according to the present disclosure will be described below with reference to FIG. 6.

As with the gas turbine plant of the first embodiment, the gas turbine plant of the present embodiment is provided with a gas turbine 10, the denitrification device 20, the waste heat recovery boiler 21, the steam turbine 23, the condenser 24, the pump 25, a fuel supply system 40a, and the control device 60. However, the fuel supply system 40a of the present embodiment is different from the fuel supply system 40 of the first embodiment.

As with the fuel supply system 40 of the first embodiment, the fuel supply system 40a includes the ammonia tank 41, the main ammonia line 42, the main ammonia pump 44, the vaporizer 45, the gaseous ammonia line 46, the liquid ammonia line 47, the switching device 48, the heating medium line 53, the heating medium valve 54, and the heating medium recovery line 55. However, the fuel supply system 40a of the present embodiment is different from the fuel supply system 40 of the first embodiment in that it does not include the flow control valve 43, the gaseous ammonia compressor 51, and the liquid ammonia pump 52. Thus, in the present embodiment, the liquid ammonia flow control valve 48i and the gaseous ammonia flow control valve 48g configuring the switching device 48 function as the flow control valve 43 in the first embodiment. In addition, in the present embodiment, the main ammonia pump 44 functions as the gaseous ammonia compressor 51 and the liquid ammonia pump 52.

As described above, the fuel supply system 40a of the present embodiment is different from the fuel supply system 40 of the first embodiment in that it does not include the flow control valve 43, the gaseous ammonia compressor 51, and the liquid ammonia pump 52. Thus, according to the present embodiment, equipment manufacturing costs are less than that of the first embodiment.

### Third Embodiment

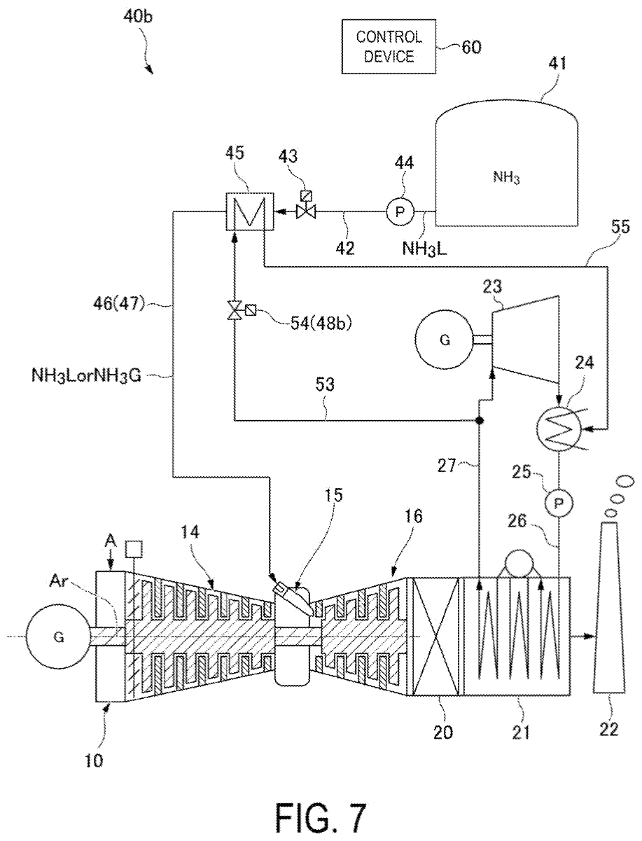

The third embodiment of a gas turbine plant according to the present disclosure will be described below with reference to FIG. 7.

As with the gas turbine plant of the first embodiment and the second embodiment, the gas turbine plant of the present embodiment is provided with a gas turbine 10, the denitrification device 20, the waste heat recovery boiler 21, the steam turbine 23, the condenser 24, the pump 25, a fuel supply system 40b, and the control device 60. However, the fuel supply system 40b of the present embodiment is different from the fuel supply system 40 of the first embodiment and the fuel supply system 40a of the second embodiment.

As with the fuel supply system 40 of the first embodiment, the fuel supply system 40b includes the ammonia tank 41, the main ammonia line 42, the flow control valve 43, the main ammonia pump 44, the vaporizer 45, the gaseous ammonia line 46, a switching device 48b, the heating medium line 53, the heating medium valve 54, and the heating medium recovery line 55. However, in the fuel supply system 40b of the present embodiment, the gaseous ammonia line 46 also functions as the liquid ammonia line 47 in the first embodiment. Thus, in the fuel supply system 40b of the present embodiment, the liquid ammonia line 47 independent of the gaseous ammonia line 46 does not exist. As with the fuel supply system 40a of the second embodiment, the fuel supply system 40b of the present embodiment does not include the gaseous ammonia compressor 51 and the liquid ammonia pump 52. Additionally, the switching device 48b of the present embodiment includes the heating medium valve 54 but does not include the liquid ammonia flow control valve 48i and the gaseous ammonia flow control valve 48g, as with the switching device 48 of the first embodiment and the second embodiment.

In the present embodiment, when the second state is implemented, the heating medium valve 54 is closed. As a result, the steam, which is the heating medium, is not guided to the vaporizer 45, and even when the liquid ammonia NH₃(l) from the main ammonia line 42 flows to the vaporizer 45, the liquid ammonia NH₃(l) is not heated by the heating medium and exits from the vaporizer 45 in an unchanged state. The liquid ammonia NH₃(l) is guided to the fuel nozzle 15n of the combustor 15 via the gaseous ammonia line 46 also functioning as the liquid ammonia line 47.

Also, in the present embodiment, when the first state is implemented, the heating medium valve 54 is opened. As a result, the steam, which is the heating medium, is guided to the vaporizer 45, and when the liquid ammonia NH₃(l) from the main ammonia line 42 flows to the vaporizer 45, the liquid ammonia NH₃(l) is heated by the heating medium and flows from the vaporizer 45 after being vaporized. The gaseous ammonia NH₃(g) is guided to the fuel nozzle 15n of the combustor 15 via the gaseous ammonia line 46 also functioning as the liquid ammonia line 47.

As described above, in the fuel supply system 40b of the present embodiment, the gaseous ammonia line 46 also functions as the liquid ammonia line 47. Thus, the equipment manufacturing costs are less than that of the first embodiment and the second embodiment.

Note that, in the fuel supply system 40b of the present embodiment, the liquid ammonia line 47 independent of the gaseous ammonia line 46 does not exist. Thus, as in the first embodiment and the second embodiment, the fuel nozzle 15n of the present embodiment does not include two types of fuel flow paths and only includes one type of fuel flow path.

In the waste heat recovery boiler 21, in the process of converting water to steam, hot water is generated. Thus, in the embodiments described above, this hot water may be used as the heating medium, i.e., the heat exchange partner with the liquid ammonia NH₃(l).

### First Modified Example

In the first embodiment, as described with reference to FIG. 4, when the fuel flow rate transitions from a low fuel flow rate, through the α % fuel flow rate, to a high fuel flow rate and when the fuel flow rate transitions from a high fuel flow rate, through the α % fuel flow rate, to a low fuel flow rate, the α % fuel flow rate is maintained for a predetermined amount of time or more. However, during the transition as described above, the α % fuel flow rate may not be maintained for a predetermined amount of time or more.

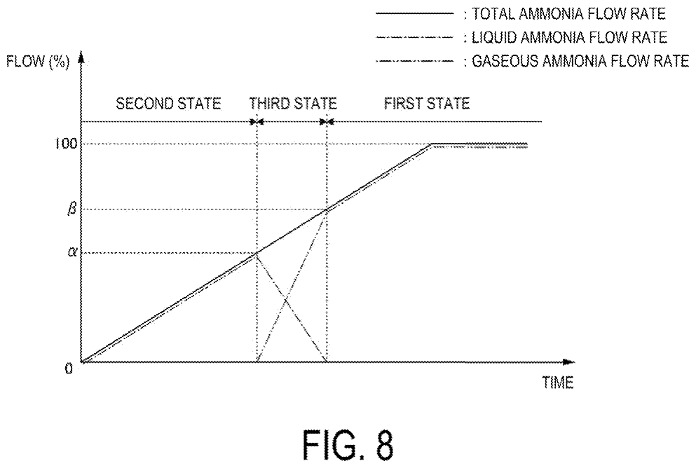

Here, as illustrated in FIG. 8, a fuel flow rate percentage greater than α % but less than 100% is defined as β %. Also, the amount of fuel supplied to the gas turbine 10 linearly increases over time during the time period from startup to rated operation. Thus, in this example, the amount of fuel supplied to the gas turbine 10 linearly increases over time during the time from startup to rated operation and specifically between the time of α % fuel flow rate and the time of β % fuel flow rate.

In the present modified example, when the fuel flow rate percentage is a low fuel flow rate less than α %, the second state is implemented, when the fuel flow rate percentage is a high fuel flow rate greater than β %, the first state is implemented, and when the fuel flow rate percentage is β % or greater and β % or less, the third state is implemented.

In the third state that is implemented when the fuel flow rate percentage is α % or greater and β % or less while transitioning from a low fuel flow rate to a high fuel flow rate, the liquid ammonia flow control valve 48i gradually closes over time and the flow rate of the liquid ammonia NH₃(l) guided to the combustor 15 gradually decreases over time. On the other hand, the gaseous ammonia flow control valve 48g gradually opens over time and the flow rate of the gaseous ammonia NH₃(g) guided to the combustor 15 gradually increases over time. Also, in the third state that is implemented when the fuel flow rate percentage is α % or greater and β % or less while transitioning from a high fuel flow rate to a low fuel flow rate, the gaseous ammonia flow control valve 48g gradually closes over time and the flow rate of the gaseous ammonia NH₃(g) guided to the combustor 15 gradually decreases over time. On the other hand, the liquid ammonia flow control valve 48i gradually opens over time and the flow rate of the liquid ammonia NH₃(l) guided to the combustor 15 gradually increases over time.

### Second Modified Example

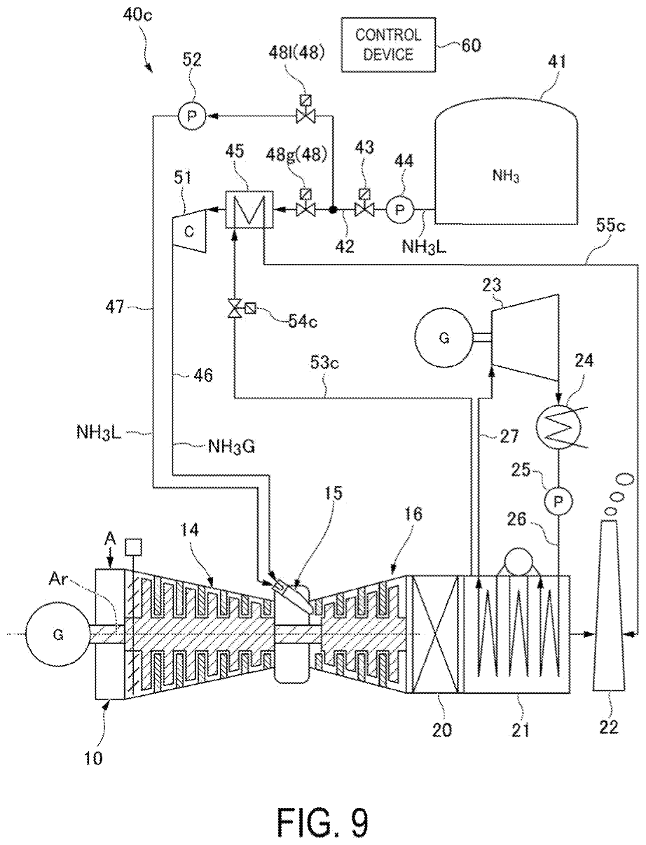

In the embodiments described above, steam or hot water generated at the waste heat recovery boiler 21 may be used as the heating medium, i.e., the heat exchange partner with the liquid ammonia NH₃(l). However, exhaust gas that flows through the waste heat recovery boiler 21 may be used as the heating medium, i.e., the heat exchange partner with the liquid ammonia NH₃(l). A modified example in which exhaust gas that flows in the waste heat recovery boiler 21 may be used as the heating medium, i.e., the heat exchange partner with the liquid ammonia NH₃(l), will now be described with reference to FIG. 9.

A fuel supply system 40c of the modified example is a modified example of the fuel supply system 40 of the first embodiment. Some of the exhaust gas flowing in the waste heat recovery boiler 21 is guided to the vaporizer 45 of the present modified example. Thus, one end of a heating medium line 53c is connected to the medium inlet of the vaporizer 45 of the present modified example, and the other end of the heating medium line 53c is connected to the waste heat recovery boiler 21. The heating medium line 53c is provided with a heating medium valve 54c that adjusts the flow rate of the exhaust gas flowing through the heating medium line 53c. One end of a heating medium recovery line 55c is connected to the medium outlet of the vaporizer 45. The other end of the heating medium recovery line 55c is connected to the stack 22, for example. Note that the other end of the heating medium recovery line 55c may be connected at a position on the waste heat recovery boiler 21, rather than the stack 22, located downstream from a position where the other end of the heating medium line 53c is connected. Here, downstream refers to the downstream side of the flow of exhaust gas flowing in the waste heat recovery boiler 21.

### Third Modified Example

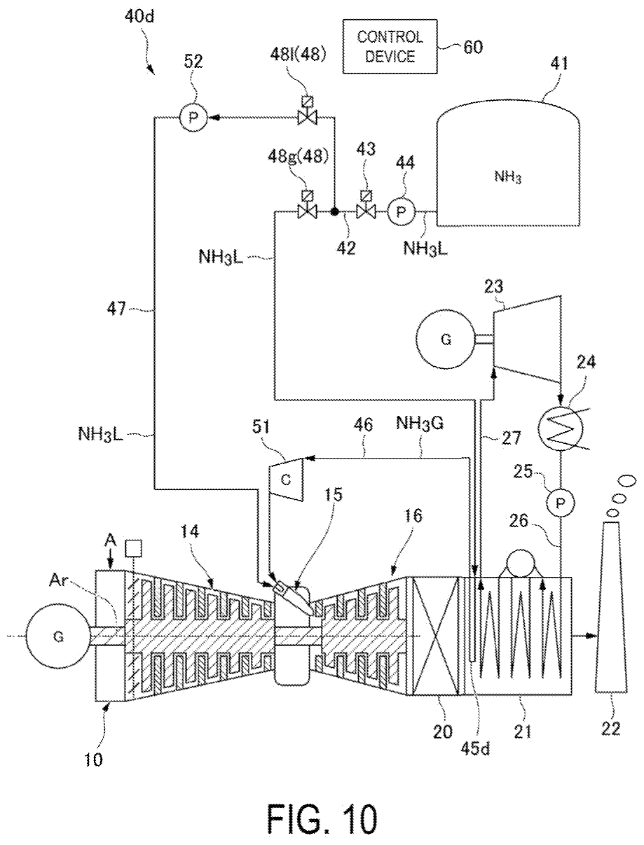

The fuel supply system 40c of the second modified example described above is a fuel supply system in which the vaporizer 45 is disposed outside the waste heat recovery boiler 21 configured such that the exhaust gas in the waste heat recovery boiler 21 is guided to the vaporizer 45. However, as illustrated in FIG. 10, a heat transfer tube 45d as a vaporizer is disposed in the waste heat recovery boiler 21, and the liquid ammonia NH₃(l) may flow through the heat transfer tube 45d and the liquid ammonia NH₃(l) may be heated by the exhaust gas flowing outside the heat transfer tube 45d inside the waste heat recovery boiler 21. In the case of a fuel supply system 40d, the end of the main ammonia line 42 is connected to one end of the heat transfer tube 45d and one end of the gaseous ammonia line 46 is connected to the other end of the heat transfer tube 45d.

Note that the fuel supply system 40d of the third modified example and the fuel supply system 40c of the second modified example are modified examples of the fuel supply system 40 of the first embodiment, but in the fuel supply system 40a of the second embodiment and the fuel supply system 40b of the third embodiment, as with the third modified example and the second modified example, exhaust gas that flows in the waste heat recovery boiler 21 may be used as the heating medium, i.e., the heat exchange partner with the liquid ammonia NH₃(l).

Herein, embodiments and modified examples of the present disclosure have been described in detail. However, the present disclosure is not limited by the embodiments and modified examples described above. Various additions, changes, substitutions, partial deletions, and the like can be made without departing from the scope and the spirit of the present invention derived from the contents and equivalents thereof defined in the claims.

### Supplementary Notes

The fuel supply system according to the embodiments described above can be understood, for example, as follows.

(1) A fuel supply system according to a first aspect includes a main ammonia line 42 connected to an ammonia tank 41 configured to store liquid ammonia NH₃(l); a main ammonia pump 44 provided on the main ammonia line 42, the main ammonia pump 44 configured to pressurize the liquid ammonia NH₃(l) from the ammonia tank 41; a vaporizer 45 connected to an end of the main ammonia line 42, the vaporizer 45 configured to heat and vaporize the liquid ammonia NH₃(l) via heat exchange between a heating medium and the liquid ammonia NH₃(l) pressurized by the main ammonia pump 44; a gaseous ammonia line 46 connected to the vaporizer 45, the gaseous ammonia line 46 configured to guide gaseous ammonia NH₃(g), which is ammonia vaporized by the vaporizer 45, as fuel to a combustor 15 of a gas turbine 10; a liquid ammonia line 47 configured to guide liquid ammonia NH₃(l), which is liquid ammonia pressurized by the main ammonia pump 44 and that has not undergone heat exchange with the heating medium at the vaporizer 45, as fuel to the combustor 15; and a switching device 48, 48b configured to switch an ammonia supply state between a plurality of states including a first state in which the gaseous ammonia NH₃(g) is guided from the gaseous ammonia line 46 to the combustor 15 and a second state in which the liquid ammonia NH₃(l) is guided from the liquid ammonia line 47 to the combustor 15.

In the present aspect, the gaseous ammonia NH₃(g) can be guided to the combustor 15 and the liquid ammonia NH₃(l) can be guided to the combustor 15. In a case in which the liquid ammonia NH₃(l) is sprayed from the fuel nozzle 15n of the combustor 15 as fuel, misfire and the like can be reduced and the fuel can be stably combusted. On the other hand, in a case in which the gaseous ammonia NH₃(g) is sprayed from the fuel nozzle 15n of the combustor 15 as fuel, the generation of NOx can be suppressed. When the fuel flow rate is low, the likelihood of the fuel misfiring is high. However, because the flow rate of ammonia is low, the amount of NOx generated is low. Conversely, when the fuel flow rate is high, the likelihood of the fuel misfiring is low. However, because the flow rate of ammonia is high, the amount of NOx generated is high. Thus, when the fuel flow rate is low, the liquid ammonia NH₃(l) is guided to the combustor 15 to reduce the likelihood of the fuel misfiring and to stably combust the fuel. Also, when the fuel flow rate is high, in order to suppress the generation of NOx, the gaseous ammonia NH₃(g) is guided to the combustor 15. As a result, in the present aspect, ammonia can be stably combusted and NOx generation can be suppressed.

(2) The fuel supply system according to a second aspect is the fuel supply system according to the first aspect, wherein the switching device 48, 48b is configured to switch an ammonia supply state between a third state in which the gaseous ammonia NH₃(g) from the gaseous ammonia line 46 and the liquid ammonia NH₃(l) from the liquid ammonia line 47 are guided to the combustor 15, the first state, and the second state.

In a case in which the state transitions from a state in which only the gaseous ammonia NH₃(g) is being guided to the combustor 15 to a state in which only the liquid ammonia NH₃(l) is being guided to the combustor 15 or conversely in a case in which the state transitions from a state in which only the liquid ammonia NH₃(l) is being guided to the combustor 15 to a state in which only the gaseous ammonia NH₃(g) is being guided to the combustor 15, if the phase of the fuel sprayed from the fuel nozzle 15n of the combustor 15 suddenly changes, the stability of the fuel combustion is impaired. Thus, in the present aspect, the third state is implemented during transition from the first state to the second state or during transition from the second state to the first state. Thus, in the present aspect, the stability of the combustion of the fuel can be ensured in the transition process described above.

(3) The fuel supply system according to a third aspect is the fuel supply system according to the first aspect or the second aspect, further including a flow control valve 43 that adjusts a flow rate of the fuel supplied to the combustor 15.

(4) The fuel supply system according to a fourth aspect is the fuel supply system according to any one of the first to third aspects, wherein an end of the liquid ammonia line 47 is connected to the main ammonia line 42 at a position between the main ammonia pump 44 and the vaporizer 45.

(5) The fuel supply system according to a fifth aspect is the fuel supply system according to the fourth aspect, in which the switching device 48 is a valve 48g, 48i configured to switch an ammonia supply state between a state in which the liquid ammonia NH₃(l) pressurized by the main ammonia pump 44 is guided to the vaporizer 45 to implement the first state and a state in which the liquid ammonia NH₃(l) pressurized by the main ammonia pump 44 is guided to the liquid ammonia line 47 to implement the second state.

(6) The fuel supply system according to a sixth aspect is the fuel supply system according to the fourth or fifth aspect, further including a liquid ammonia pump 52 provided on the liquid ammonia line 47, the liquid ammonia pump 52 configured to pressurize the liquid ammonia NH₃(l) flowing through the liquid ammonia line 47; and a gaseous ammonia compressor 51 provided on the gaseous ammonia line 46, the gaseous ammonia compressor 51 configured to pressurize the gaseous ammonia NH₃(g) flowing through the gaseous ammonia line 46.

In this aspect, the target pressure of the liquid ammonia NH₃(l) guided to the combustor 15 via the liquid ammonia line 47 can be easily achieved, and the target pressure of the gaseous ammonia NH₃(g) guided to the combustor 15 via the gaseous ammonia line 46 can be easily achieved.

(7) The fuel supply system according to a seventh aspect is the fuel supply system according to any one of the first to third aspects, in which the gaseous ammonia line 46 also functions as the liquid ammonia line 47. Also, the switching device 48b is a heating medium valve 54 that switches a supply state of the heating medium between a state in which the heating medium is guided to the vaporizer 45 to implement the first state and a state in which the heating medium is not guided to the vaporizer 45 to implement the second state.

In the present aspect, the gaseous ammonia line 46 also functions as the liquid ammonia line 47. Thus, the line configuration can be simplified and the equipment manufacturing costs can be reduced.

(8) The fuel supply system according to an eighth aspect is the fuel supply system according to any one of the first to seventh aspects, further including a control device 60 configured to receive an external output request for the gas turbine, determine one state from among a plurality of states including the first state and the second state according to the output request, and instruct the switching device 48, 48b to implement the one state.

The flow rate of the fuel supplied to the combustor 15 changes according to the output request. The control device 60 of the present aspect sets the state to one state from among the plurality of states including the first state and the second state according to the output request. Thus, in the present aspect, the fuel supply state when the fuel flow rate is high can be set to the first state and the fuel supply state when the fuel flow rate is low can be set to the second state.

The fuel combustion system according to the embodiments described above can be understood, for example, as follows.

(9) A fuel combustion system according to a ninth aspect includes the fuel supply system according to any one of the first to eighth aspects and the combustor 15 that combusts the fuel from the fuel supply system 40 in a compressed air Acom and generates combustion gas.

(10) The fuel combustion system according to a tenth aspect is the fuel combustion system according to the ninth aspect, in which the combustor 15 includes a combustion chamber forming device 15c that forms a combustion chamber 15s configured to combust the fuel and guide the combustion gas generated by combustion of the fuel to a turbine 16, and a combustor main body 15b configured to spray the fuel and the compressed air Acom into the combustion chamber 15s. The combustor main body 15b includes a fuel nozzle 15n configured to spray the fuel into the combustion chamber 15s. The fuel nozzle 15n includes a fuel gas flow path 34 connected to the gaseous ammonia line 46, the fuel gas flow path 34 configured to spray the gaseous ammonia NH₃(g) from the gaseous ammonia line 46 into the combustion chamber 15s, and a liquid fuel flow path 33 connected to the liquid ammonia line 47, the liquid fuel flow path 33 configured to spray the liquid ammonia NH₃(l) from the liquid ammonia line 47 into the combustion chamber 15s.

The gas turbine plant according to the embodiments described above can be understood, for example, as follows.

(11) A gas turbine plant according to an eleventh aspect includes the fuel supply system according to any one of the first to eighth aspects; and the gas turbine 10. The gas turbine 10 includes a compressor 14 that compresses air to generate the compressed air Acom, the combustor 15 that combusts the fuel from the fuel supply system 40 in the compressed air Acom to generate combustion gas, and a turbine 16 configured to be driven by the combustion gas.

(12) The gas turbine plant according to a twelfth aspect is the gas turbine plant according to the eleventh aspect, wherein the combustor 15 includes a combustion chamber forming device 15c that forms the combustion chamber 15s configured to combust the fuel and guide the combustion gas generated by combustion of the fuel to the turbine 16, and a combustor main body 15b configured to spray the fuel and the compressed air Acom into the combustion chamber 15s. The combustor main body 15b includes a fuel nozzle 15n configured to spray the fuel into the combustion chamber 15s. The fuel nozzle 15n includes a fuel gas flow path 34 connected to the gaseous ammonia line 46, the fuel gas flow path 34 configured to spray the gaseous ammonia NH₃(g) from the gaseous ammonia line 46 into the combustion chamber 15s, and a liquid fuel flow path 33 connected to the liquid ammonia line 47, the liquid fuel flow path 33 configured to spray the liquid ammonia NH₃(l) from the liquid ammonia line 47 into the combustion chamber 15s.

In the present aspect, the gaseous ammonia NH₃(g) and the liquid ammonia NH₃(l) can be sprayed from the fuel nozzle 15n at the same time.

(13) The gas turbine plant according to a thirteenth aspect is the gas turbine plant according to the eleventh or twelfth aspect, further including a waste heat recovery boiler 21 that utilizes heat from exhaust gas, which is the combustion gas exhausted from the turbine 16, to generate steam; and a heating medium line 53 that guides some of the steam generated at the waste heat recovery boiler 21 or some of water heated at the waste heat recovery boiler 21 as the heating medium to the vaporizer 45.

(14) The gas turbine plant according to a fourteenth aspect is the gas turbine plant according to the eleventh or twelfth aspect, wherein the vaporizer 45 is configured to heat and vaporize the liquid ammonia NH₃(l) via heat exchange between an exhaust gas, which is the combustion gas exhausted from the turbine 16 as the heating medium, and the liquid ammonia NH₃(l) pressurized by the main ammonia pump 44.

The fuel supply method according to the embodiments described above can be understood, for example, as follows.

(15) A fuel supply method according to a fifteenth aspect includes pressurizing S1 liquid ammonia NH₃(l) from an ammonia tank 41 storing the liquid ammonia NH₃(l); vaporizing S5 the liquid ammonia NH₃(l) by heating the liquid ammonia via heat exchange between a heating medium and the liquid ammonia NH₃(l) pressurized in the pressurizing S1; and switching S6 an ammonia supply state between a plurality of states including a first state in which a gaseous ammonia NH₃(g), which is ammonia vaporized in the vaporizing S5, is guided to a combustor 15 of a gas turbine 10 as fuel and a second state in which liquid ammonia NH₃(l), which is liquid ammonia NH₃(l) pressurized in the pressurizing S1 which has not undergone heat exchange with the heating medium in the vaporizing S5, is guided to the combustor 15 as fuel.

As with the first aspect described above, according to the present aspect, ammonia can be stably combusted and NOx generation can be suppressed.

(16) The fuel supply method according to a sixteenth aspect is the fuel supply method according to the fifteenth aspect, wherein in the switching S6, an ammonia supply state is switched between a third state in which the gaseous ammonia NH₃(g) and the liquid ammonia NH₃(l) are guided to the combustor 15, the first state, and the second state.

As with the second aspect described above, according to the present aspect, the third state is implemented during transition from the first state to the second state or during transition from the second state to the first state. Thus, stable combustion of the fuel during the transitions described above can be ensured.

(17) The fuel supply method according to a seventeenth aspect is the fuel supply method according to the fifteenth or sixteenth aspect, further including adjusting S2 a flow rate of the fuel supplied to the combustor 15.

(18) The fuel supply method according to an eighteenth aspect is the fuel supply method according to any one of the fifteenth to seventeenth aspects, in which, in the vaporizing S5, the liquid ammonia NH₃(l) pressurized in the pressurizing S1 is introduced, the heating medium is introduced, and vaporization is performed at the vaporizer 45 via heat exchange between the liquid ammonia NH₃(l) and the heating medium. In the switching S6, an ammonia supply state is switched between a state in which the liquid ammonia NH₃(l) pressurized in the pressurizing S1 is guided to the vaporizer 45 to implement the first state and a state in which the liquid ammonia NH₃(l) pressurized in the pressurizing S1 is not guided to the vaporizer 45 to implement the second state.

(19) The fuel supply method according to a nineteenth aspect is the fuel supply method according to any one of the fifteenth to seventeenth aspects, in which, in the vaporizing S5, the liquid ammonia NH₃(l) pressurized in the pressurizing S1 is introduced, the heating medium is introduced, and vaporization is performed at the vaporizer 45 via heat exchange between the liquid ammonia NH₃(l) and the heating medium. Also, in the switching S6, a supply state of the heating medium is switched between a state in which the heating medium is guided to the vaporizer 45 to implement the first state and a state in which the heating medium is not guided to the vaporizer 45 to implement the second state.

(20) The fuel supply method of a twentieth aspect is the fuel supply method according to any one of the fifteenth to nineteenth aspects, further including controlling S3 to receive an external output request for the gas turbine, determine one state from among a plurality of states including the first state and the second state according to the output request, and implement the one state in the switching S6.

The flow rate of the fuel supplied to the combustor 15 changes according to the output request. Thus, as with the eighth aspect described above, according to the present aspect, the fuel supply state when the fuel flow rate is high can be set to the first state and the fuel supply state when the fuel flow rate is low can be set to the second state.

(21) The fuel supply method according to a twenty-first aspect is the fuel supply method according to any one of the fifteenth to twentieth aspects, further including generating S4 steam by utilizing heat of exhaust gas exhausted from the gas turbine 10, wherein in the vaporizing S5, some of the steam generated in the generating S4 or hot water generated during the generating S4 is used as the heating medium.

(22) The fuel supply method according to a twenty-second aspect is the fuel supply method according to any one of the fifteenth to twentieth aspects, in which, in the vaporizing S5, exhaust gas exhausted from the gas turbine 10 is used as the heating medium.

### INDUSTRIAL APPLICABILITY

According to an aspect of the present disclosure, ammonia can be stably combusted and NOx generation can be suppressed.

### REFERENCE SIGNS LIST

10 Gas turbine
11 Gas turbine rotor
12 Intermediate casing
14 Compressor
14r Compressor rotor
14c Compressor casing
14i Inlet guide vane (or IGV)
15 Combustor
15c Combustion liner (or transition piece or combustion chamber forming device)
15s Combustion chamber
15b Combustor main body
15n Fuel nozzle
16 Turbine
16r Turbine rotor
16c Turbine casing
20 Denitrification device
21 Waste heat recovery boiler
22 Stack
23 Steam turbine
24 Condenser
25 Pump
26 Feedwater line
27 Main steam line
31 Inner cylinder
32 External cylinder
33 Liquid fuel flow path
33i Liquid fuel inlet
33o Liquid fuel spray port
34 Fuel gas flow path
34i Fuel gas inlet
34o Fuel gas spray port
40, 40a, 40b, 40c, 40d Fuel supply system
41 Ammonia tank
42 Main ammonia line
43 Flow control valve
44 Main ammonia pump
45 Vaporizer
45d Heat transfer tube (vaporizer)
46 Gaseous ammonia line
47 Liquid ammonia line
48, 48b Switching device
48g Gaseous ammonia flow control valve
48i Liquid ammonia flow control valve
51 Gaseous ammonia compressor
52 Liquid ammonia pump
53 Heating medium line
54 Heating medium valve
55 Heating medium recovery line
60 Control device
A Air
Acom Compressed air
NH₃(g) Gaseous ammonia
NH₃(l) Liquid ammonia
An Nozzle axis
Ar Rotor axis
Da Axial direction
Dab Back side
Daf Front side

What is claimed is:

1. A fuel supply system comprising:
a main ammonia line connected to an ammonia tank configured to store liquid ammonia;
a main ammonia pump provided on the main ammonia line, the main ammonia pump configured to pressurize the liquid ammonia from the ammonia tank;
a vaporizer connected to an end of the main ammonia line, the vaporizer configured to heat and vaporize the liquid ammonia via heat exchange between a heating medium and the liquid ammonia pressurized by the main ammonia pump;
a gaseous ammonia line connected to the vaporizer, the gaseous ammonia line configured to guide gaseous ammonia, which is the ammonia vaporized by the vaporizer, as fuel to a combustor of a gas turbine;
a liquid ammonia line configured to guide liquid ammonia, which is the liquid ammonia pressurized by the main ammonia pump and that has not undergone heat exchange with the heating medium at the vaporizer, as fuel to the combustor; and
a switching device configured to switch an ammonia supply state between a plurality of states including a first state in which the gaseous ammonia is guided from the gaseous ammonia line to the combustor and a second state in which the liquid ammonia is guided from the liquid ammonia line to the combustor.

2. The fuel supply system according to claim 1, wherein
the switching device is configured to switch an ammonia supply state between a third state in which the gaseous ammonia from the gaseous ammonia line and the liquid ammonia from the liquid ammonia line are guided to the combustor, the first state, and the second state.

3. The fuel supply system according to claim 1, further comprising:
a flow control valve that adjusts a flow rate of the fuel supplied to the combustor.

4. The fuel supply system according to claim 1, wherein
an end of the liquid ammonia line is connected to the main ammonia line at a position between the main ammonia pump and the vaporizer.

5. The fuel supply system according to claim 4, wherein
the switching device is a valve configured to switch an ammonia supply state between a state in which the liquid ammonia pressurized by the main ammonia pump is guided to the vaporizer to implement the first state and a state in which the liquid ammonia pressurized by the main ammonia pump is not guided to the liquid ammonia line to implement the second state.

6. The fuel supply system according to claim 4, further comprising:
a liquid ammonia pump provided on the liquid ammonia line, the liquid ammonia pump configured to pressurize the liquid ammonia flowing through the liquid ammonia line; and
a gaseous ammonia compressor provided on the gaseous ammonia line, the gaseous ammonia compressor configured to pressurize the gaseous ammonia flowing through the gaseous ammonia line.

7. The fuel supply system according to claim 1, wherein
the gaseous ammonia line also functions as the liquid ammonia line; and
the switching device is a heating medium valve that switches a supply state of the heating medium between a state in which the heating medium is guided to the vaporizer to implement the first state and a state in which the heating medium is not guided to the vaporizer to implement the second state.

8. The fuel supply system according to claim 1, further comprising:
a control device configured to receive an external output request for the gas turbine, determine one state from among a plurality of states including the first state and the second state according to the output request, and instruct the switching device to implement the one state.

9. A fuel combustion system comprising:
the fuel supply system according to claim 1; and
the combustor that combusts the fuel from the fuel supply system in compressed air and generates combustion gas.

10. The fuel combustion system according to claim 9, wherein
the combustor includes
a combustion chamber forming device that forms a combustion chamber configured to combust the fuel and guide the combustion gas generated by combustion of the fuel to a turbine, and
a combustor main body configured to spray the fuel and compressed air into the combustion chamber,
the combustor main body includes a fuel nozzle configured to spray the fuel into the combustion chamber, and
the fuel nozzle includes
a fuel gas flow path connected to the gaseous ammonia line, the fuel gas flow path configured to spray the gaseous ammonia from the gaseous ammonia line into the combustion chamber, and
a liquid fuel flow path connected to the liquid ammonia line, the liquid fuel flow path configured to spray the liquid ammonia from the liquid ammonia line into the combustion chamber.

11. A gas turbine plant comprising:
the fuel supply system according to claim 1; and
the gas turbine, wherein
the gas turbine includes
a compressor that compresses air to generate compressed air,
the combustor that combusts the fuel from the fuel supply system in the compressed air to generate combustion gas, and
a turbine configured to be driven by the combustion gas.

12. The gas turbine plant according to claim 11, wherein
the combustor includes
a combustion chamber forming device that forms a combustion chamber configured to combust the fuel and guide the combustion gas generated by combustion of the fuel to the turbine, and
a combustor main body configured to spray the fuel and the compressed air into the combustion chamber,
the combustor main body includes a fuel nozzle configured to spray the fuel into the combustion chamber, and
the fuel nozzle includes
a fuel gas flow path connected to the gaseous ammonia line, the fuel gas flow path configured to spray the gaseous ammonia from the gaseous ammonia line into the combustion chamber, and
a liquid fuel flow path connected to the liquid ammonia line, the liquid fuel flow path configured to spray the liquid ammonia from the liquid ammonia line into the combustion chamber.

13. The gas turbine plant according to claim 11, further comprising:
a waste heat recovery boiler that utilizes heat from exhaust gas, which is the combustion gas exhausted from the turbine, to generate steam; and
a heating medium line that guides some of the steam generated at the waste heat recovery boiler or some of water heated at the waste heat recovery boiler as the heating medium to the vaporizer.

14. The gas turbine plant according to claim 11, wherein
the vaporizer is configured to heat and vaporize the liquid ammonia via heat exchange between an exhaust gas, which is the combustion gas exhausted from the turbine as the heating medium, and the liquid ammonia pressurized by the main ammonia pump.

15. A fuel supply method comprising:
pressurizing liquid ammonia from an ammonia tank storing the liquid ammonia;
vaporizing the liquid ammonia by heating the liquid ammonia via heat exchange between a heating medium and the liquid ammonia pressurized in the pressurizing; and
switching an ammonia supply state between a plurality of states including a first state in which a gaseous ammonia, which is ammonia vaporized in the vaporizing, is guided to a combustor of a gas turbine as fuel, and a second state in which liquid ammonia, which is liquid ammonia pressurized in the pressurizing and that has not undergone heat exchange with the heating medium in the vaporizing, is guided to the combustor as fuel.

16. The fuel supply method according to claim 15, wherein
in the switching, an ammonia supply state is switched between a third state in which the gaseous ammonia and the liquid ammonia are guided to the combustor, the first state, and the second state.

17. The fuel supply method according to claim 15, further comprising:
adjusting a flow rate of the fuel supplied to the combustor.

18. The fuel supply method according to claim 15, wherein
in the vaporizing, the liquid ammonia pressurized in the pressurizing is introduced, the heating medium is introduced and vaporization is performed at the vaporizer via heat exchange between the liquid ammonia and the heating medium, and
in the switching, an ammonia supply state is switched between a state in which the liquid ammonia pressurized in the pressurizing is guided to the vaporizer to implement the first state and a state in which the liquid ammonia pressurized in the pressurizing is not guided to the vaporizer to implement the second state.

19. The fuel supply method according to claim 15, wherein
in the vaporizing, the liquid ammonia pressurized in the pressurizing is introduced, the heating medium is introduced, and vaporization is performed via heat exchange between the liquid ammonia and the heating medium, and
in the switching, a supply state of the heating medium is switched between a state in which the heating medium is guided to the vaporizer to implement the first state and a state in which the heating medium is not guided to the vaporizer to implement the second state.

20. The fuel supply method according to claim 15, further comprising:
controlling to receive an external output request for the gas turbine, determine one state from among a plurality of states including the first state and the second state according to the output request, and implement the one state in the switching.

21. The fuel supply method according to claim 15, further comprising:
generating steam by utilizing heat of exhaust gas exhausted from the gas turbine, wherein
in the vaporizing, some of the steam generated in the generating or hot water generated during the generating is used as the heating medium.

22. The fuel supply method according to claim 15, wherein
in the vaporizing, exhaust gas exhausted from the gas turbine is used as the heating medium.
